(19) United States
(12) Patent Application Publication
(10) Pub. No.: US 2016/0088815 A1
(43) Pub. Date: Mar. 31, 2016

(54) Cat Tree Feeder

(71) Applicant: Richard Paul Maroske, Las Vegas, NV (US)

(72) Inventor: Richard Paul Maroske, Las Vegas, NV (US)

(21) Appl. No.: 14/837,906

(22) Filed: Aug. 27, 2015

Related U.S. Application Data
(60) Provisional application No. 62/071,586, filed on Sep. 29, 2014.

(51) Int. Cl. A01K 5/01

(52) U.S. Cl. CPC A01K 5/0114

(57) ABSTRACT

The cat tree feeder allows cats to consume their food from an elevated surface without jumping to the floor, walking to the other room, and discover that the dog has eaten all of the cat food. The cat tree feeder was invented to solve the age-old problem that exists with families that own both cats and dogs; is there a simple and convenient way to keep the dog out of the cat food? The cat tree feeder is light-weight and easily attaches to a platform on a cat tree, or the edge of a table surface or the edge of a countertop surface. Additional benefits of the cat tree feeder include; no bending to access and place feeding bowls, inaccessible by small children and crawly insects, and no accidents occur like stepping upon or kicking over of the cat food bowls. The cat tree feeder literally stands above other elevated cat feeders.

### CROSS REFERENCE TO RELATED APPLICATIONS

This Non-provisional Patent Application claims priority to U.S. Provisional Patent Application No. 62/071,586 Titled, “Cat tree feeder” filed, Sep. 29, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Many households have cats and dogs as pets within the home. Dogs, small children and crawly insects have a reputation of helping themselves to easy-accessible cat food in cat feeding bowls placed on the floor.

Cats would love to be able to eat food and drink water from an elevated platform on a cat tree without jumping to the floor and walking to the other room for a snack and discover that the dog has eaten all of the cat food.

There are various elevated cat feeders in the marketplace. Many elevated cat feeders require a handyman to build and install them. These elevated cat feeders are usually permanent structures that attach to a windowsill, attach to a wall or hang from the ceiling.

Thus, the need exists to develop a TRULY elevated, simple, lightweight and convenient cat feeding device. The “Cat Tree Feeder” provides such an elevated cat feeder.

The “Cat Tree Feeder” is a structure into which a food bowl and water bowl may be inserted, hosted and attached to a cat tree, the edge of a table surface, the edge of a countertop surface or any stable and secure vertical or horizontal surface.

The “Cat Tree Feeder” will appeal to a large consumer market of over forty-five million (45,000,000) cat-owning U.S. households.

The “Cat Tree Feeder” addresses the established needs of over sixteen million (16,000,000) U.S. households that own both cats and dogs.

### BRIEF SUMMARY OF THE INVENTION

The present invention relates to a cat feeder that provides a feeding experience that cats truly enjoy—feeling safe and elevated with a constant view of their surroundings.

It is an object of the present invention to provide a cat its own peaceful environment.

An object of the present invention is to provide a food bowl and a water bowl in a location which is elevated such that a cat may access, but a dog, small children and crawly insects can't access.

An object of the present invention is to provide a food bowl and a water bowl in a location which is elevated and off of the floor such that dusty dirt settling on the cat food and dusty dirt forming a crusty top on the cat's water is prevented.

The present invention is an elevated cat feeder that prevents the occasional kicking over and stepping upon the cat feeding bowls placed upon the floor.

The present invention does not occupy any regular space of a cat tree, a table surface, a countertop surface or any stable and secure horizontal surface.

The present invention stores its food and water bowls at a raised height which reduces, if not eliminates, the need for a pet owner to bend to access and place said bowls, therefore the “Cat Tree Feeder” benefits cat owners who may be arthritic or physically limited in any other way.

### BRIEF DESCRIPTION OF SEVERAL VIEWS OF THE DRAWING

The invention will be better understood and objects other than those set forth above will become apparent when consideration is given to the following detailed description thereof. Such description makes reference to the drawings wherein;

FIG. 1 is an isometric drawing of the feeding bowls and the vertically attachable cat tree feeder.

FIG. 2 is a plan drawing of the vertically attachable cat tree feeder.

FIG. 3 is a sectional drawing of the vertically attachable cat tree feeder.

FIG. 4 is an isometric drawing of the feeding bowls and the horizontally attachable cat tree feeder.

FIG. 5 is a plan drawing of the horizontally attachable cat tree feeder.

FIG. 6 is a sectional drawing of the horizontally attachable cat tree feeder.

FIG. 7 illustrates the vertically attachable cat tree feeder attached to a vertically straight railing on a rectangular platform of a cat tree.

FIG. 8 illustrates the vertically attachable cat tree feeder attached to a vertically curved railing on a curved platform of a cat tree.

FIG. 9 illustrates the horizontally attachable cat tree feeder attached to the bottom section of a “U” shaped platform of a cat tree.

FIG. 10 illustrates the horizontally attachable cat tree feeder attached to a flat rectangular platform of a cat tree.

FIG. 11 illustrates the horizontally attachable cat tree feeder attached to the horizontal edge of a table surface.

FIG. 12 illustrates the horizontally attachable cat tree feeder attached to the horizontal edge of a countertop surface.

FIG. 13 illustrates a horizontal feeding-bowl-support-plate attached permanently to a vertically straight railing on a rectangular platform of a cat tree.

FIG. 14 illustrates a horizontal feeding-bowl-support-plate attached permanently to a vertically curved railing on a curved platform of a cat tree.

FIG. 15 illustrates a horizontal feeding-bowl-support-plate attached permanently to a flat rectangular platform of a cat tree.

### DETAILED DESCRIPTION OF THE INVENTION

The present embodiments of the invention now will be described more fully hereinafter with reference to the accompanying drawings, in which aspects of the invention are shown. The present embodiments may, however, be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

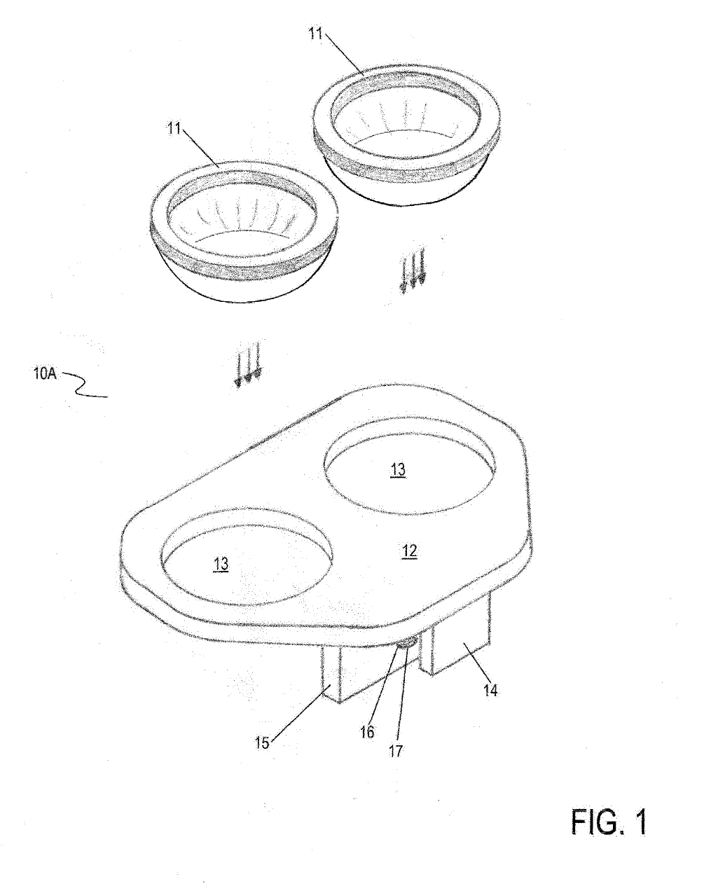

FIG. 1 provides a perspective view of the components of a vertically attachable cat tree feeder 10A, according to the present invention.

FIG. 1 illustrates shallow wide-mouthed feeding bowls 11. A shallow wide-mouthed feeding bowl 11 will accommodate a cat's face and whiskers.

The diameter of the top rim of said bowls 11 measures approximately four and three quarter inches (4¾″), featuring a depth of two inches (2″), allowing said bowls 11 to rest within while still supported by the horizontal feeding-bowl-support-plate 12 apertures 13. Said bowls 11 are made of tempered glass material.

Said bowls 11 of the vertically attachable cat tree feeder 10A may be made of various materials, including but not limited to glass, various metals and various plastics. Said bowls 11 of the vertically attachable cat tree feeder 10A may be of various capacities. Said bowls 11 of the vertically attachable cat tree feeder 10A may be of various sizes and shapes, as can the apertures 13 of the horizontal feeding-bowl-support-plate 12 in correlation to those bowls 11.

Said bowls 11 of the vertically attachable cat tree feeder 10A may or may not be included in final packaging of the product, and/or may be sold separately.

The vertically attachable cat tree feeder 10A can be made in variations that feature indentations in its horizontal feeding-bowl-support-plate 12 instead of bowls 11.

The horizontal feeding-bowl-support-plate 12 of the vertically attachable cat tree feeder 10A is made of plywood and measures approximately eleven and one-half inches in maximum length by seven and one-half inches in maximum width by one-half inch thick (11½″×7½″×½″).

Two (2) circular apertures 13 of four and one-half inch (4½″) diameter are featured on this horizontal feeding-bowl-support-plate 12. Each aperture 13 is positioned at a three-quarter inch (¾″) depth from the width-walls and one (1) of the length-walls and two and one-quarter inches (2¼″) from the opposite length-wall, at a distance of one inch (1″) from each other.

Each width-wall features an arc with a radius of three inches (3″). The length-wall, two and one-quarter inches (2¼″) from the apertures 13, narrows to four and one-half inches (4½″) from a tangent of said three inch (3″) arc and is centered three and one-half inches (3½″) from each width-wall. The obtuse corners feature a two (2″) radius arc.

The horizontal feeding-bowl-support-plate 12 can be made of various materials of applicable weight and durability, such as but not limited to polyvinyl chloride (PVC), fiberglass/resin, high-density polyethylene (HDPE), and polypropylene. Variations that use wood or various metals can also be produced, as well as variations that use a combination of materials. The horizontal feeding-bowl-support-plate 12 can be made in various sizes and shapes, including specific sizes and shapes for its application upon specific models of cat trees. The horizontal feeding-bowl-support-plate 12 can be made in variations to accommodate one (1) or more serving bowls 11. Said feeding bowls 11 shall be supported and attached as close as physically possible to a feeding cat's face/mouth. The horizontal feeding-bowl-support-plate 12 may be made in variations that feature carpeting or other material, and on any portion of its structure.

Attached perpendicularly to the horizontal feeding-bowl-support-plate 12 is a two piece brace component. The outside wall of the two piece brace component 14 is textured FIG. 3-18 on the inside to maintain secure and stable placement when in use, is featured directly below the shortest length-wall, measures approximately two inches (2″) wide by one and one-half inches (1½″) high by one-half of one inch (½″) thick, and is centered approximately one and one-quarter inches (1¼″) in from the ends of the shortened length-wall.

The inside wall of the two piece brace component 15, closest to the apertures 13, is placed approximately one and one-half inches (1½″) away from the outside wall of the two piece brace component 14.

This inside wall of the two piece brace component 15 measures approximately four and one-half inches (4½″) in maximum length by two and one-quarter inches (2¼″) high by one-half of one inch (½″) thick featuring an aperture of an approximate one-quarter inch (¼″) diameter, and through which an included thumbscrew 16 of one and one-half inch (1½″) length shall be inserted.

The two piece brace component of the horizontal feeding-bowl-support-plate 12 may be of various sizes and various widths between its two (2) vertical walls.

The textured surface FIG. 3-18 on the brace component of the vertically attachable cat tree feeder 10A, used to secure and stabilize said, can be of various patterns, and such textured surface FIG. 3-18 may be featured on any or both sides of said brace component.

The thumbscrew 16 of the vertically attachable cat tree feeder 10A can be of various sizes and shapes.

The thumbscrew 16 of the vertically attachable cat tree feeder 10A may feature, and/or be connected to a plate of various sizes, and for improved dimensions of surface area contact when applied.

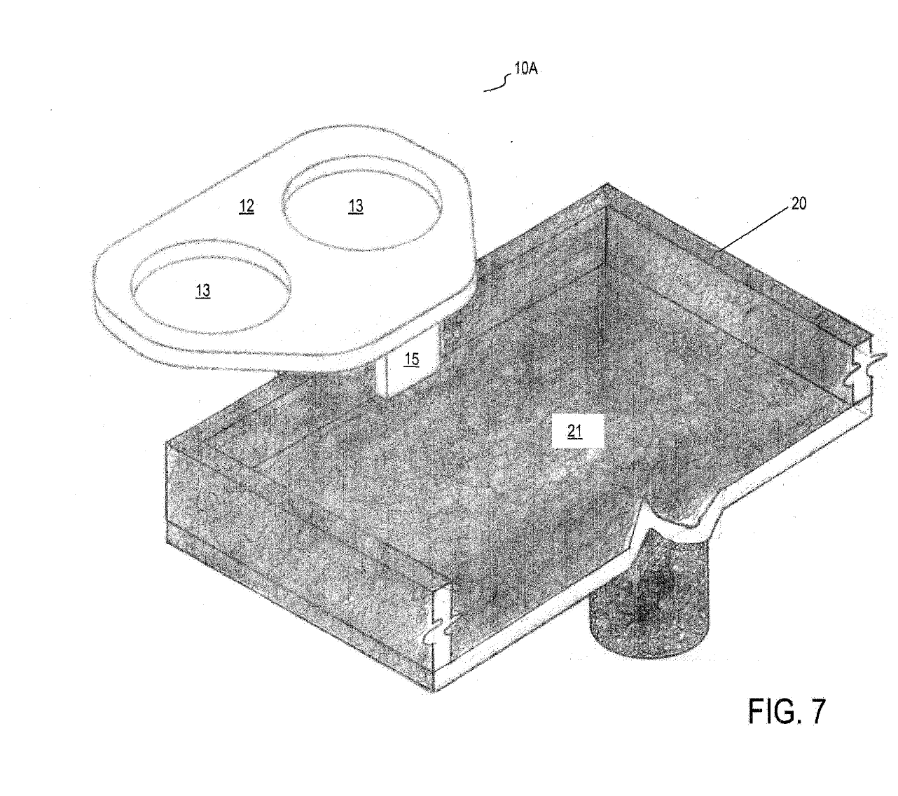

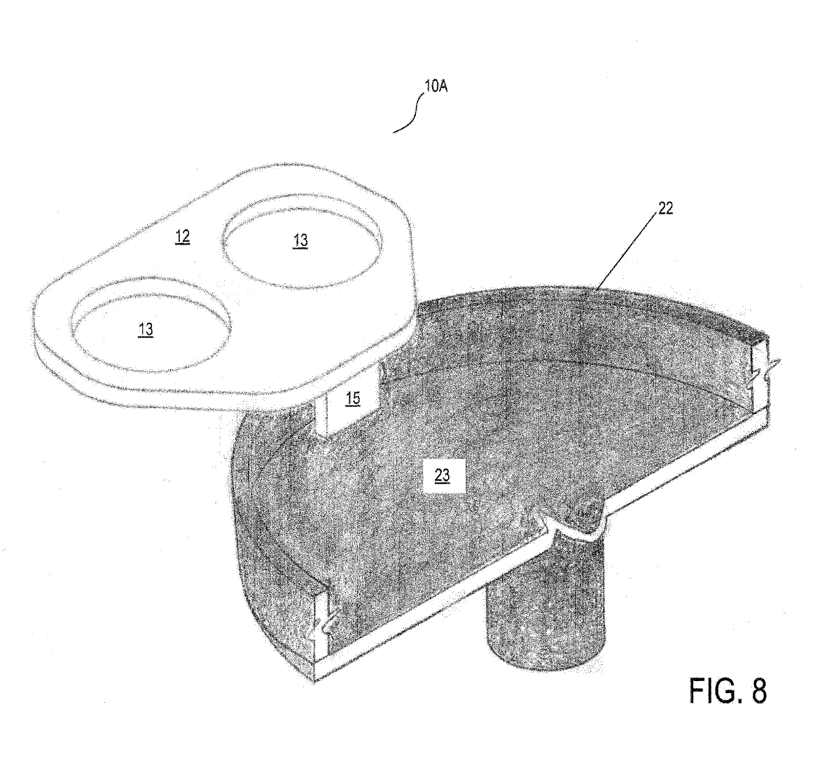

The vertically attachable cat tree feeder 10A can be secured upon a the vertically straight railing FIG. 7-20 or a vertically curved railing FIG. 8-22 on a cat tree, by various other methods, such as but not limited to brace, bracket, hook-and-loop material, ratchet clamp, hook and other means.

The vertically attachable cat tree feeder 10A can be made in variations in which its horizontal feeding-bowl-support-plate 12 features a raised wall about some or all of its perimeter, and for the purpose of preventing spillage of dry cat food. In such variations, the said wall may be of various heights and widths.

The horizontal feeding-bowl-support-plate 12 of the vertically attachable cat tree feeder 10A can be attached to its brace component by lockable hinge, allowing said horizontal feeding-bowl-support-plate 12 to be folded out of the way when not in use.

The two piece brace component of the vertically attachable cat tree feeder 10A may be made in variations in which the width between its outside wall of the two piece brace component 14 and inside wall of the two piece brace component 15 is adjustable by the user, and by various means.

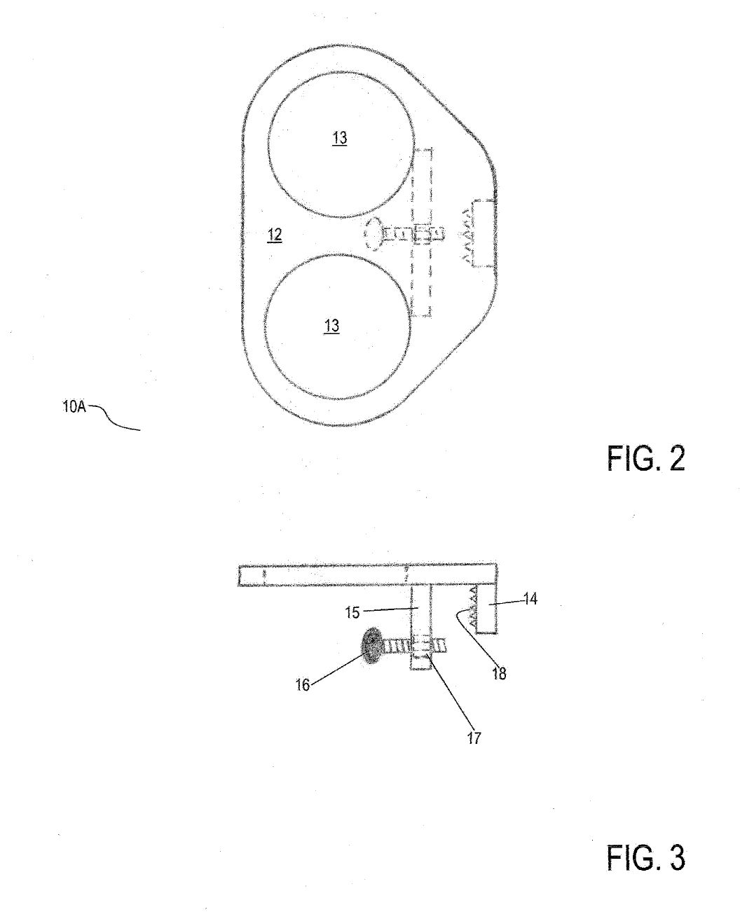

FIG. 2 and FIG. 3 provide a plan and a sectional perspective view of the components of a vertically attachable cat tree feeder 10A, according to the present invention. Said views detail the two piece brace component 14 & 15 of the vertically attachable cat tree feeder 10A. The plan view and sectional view illustrate the relation of the textured 18 outside wall of the two piece brace component 14 and the inside wall of the two piece brace component 15 that features an embedded one-quarter inch (¼″) hex nut 17 that secures the one and one-half inch (1½″) thumb screw 16.

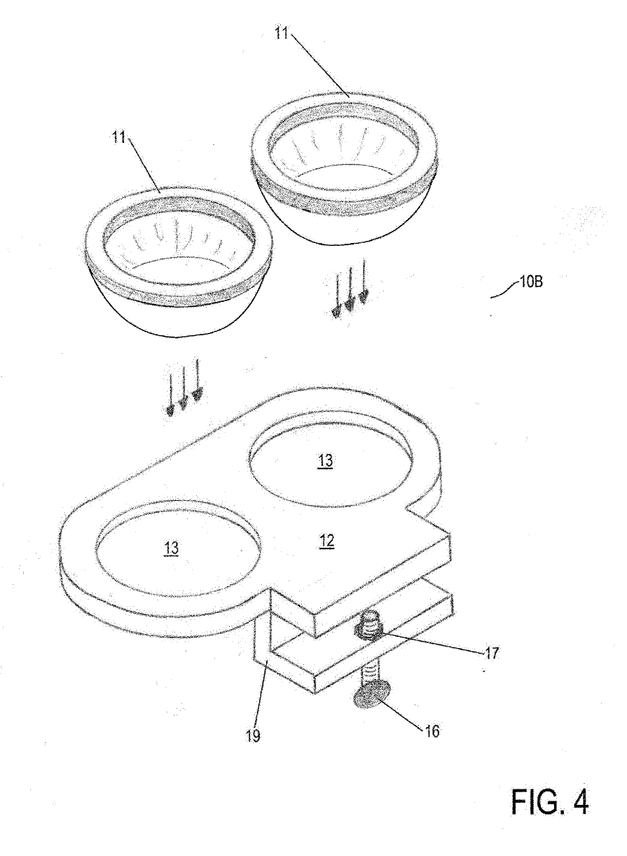

FIG. 4 provides a perspective view of the components of a horizontally attachable cat tree feeder 10B, according to the present invention.

FIG. 4 illustrates shallow wide-mouthed feeding bowls 11. A shallow wide-mouthed feeding bowl 11 will accommodate a cat's face and whiskers.

The diameter of the top rim of said bowls 11 measures approximately four and three quarter inches (4¾″), featuring a depth of two inches (2″), allowing said bowls 11 to rest within while still supported by the horizontal feeding-bowl-support-plate 12 apertures 13. Said bowls 11 are made of tempered glass material.

Said bowls 11 of the horizontally attachable cat tree feeder 10B may be made of various materials, including but not limited to glass, various metals and various plastics. Said bowls 11 of the horizontally attachable cat tree feeder 10B may be of various capacities. Said bowls 11 of the horizontally attachable cat tree feeder 10B may be of various sizes and shapes, as can the apertures 13 of the horizontal feeding-bowl-support-plate 12 of the structure in correlation to those bowls 11. Said bowls 11 of the horizontally attachable cat tree feeder 10B may or may not be included in final packaging of the product, and/or may be sold separately.

The horizontally attachable cat tree feeder 10B can be made in variations that feature indentations in its horizontal feeding-bowl-support-plate 12 instead of bowls 11.

The horizontal feeding-bowl-support-plate 12 of the horizontally attachable cat tree feeder 10B is made of plywood and measures approximately eleven and one-half inches in maximum length by seven and one-half inches in maximum width by one-half inch thick (11½″×7½″×½″).

Two (2) circular apertures 13 of four and one-half inch (4½″) diameter are featured on this horizontal feeding-bowl-support-plate 12. Each aperture 13 is positioned at a three-quarter inch (¾″) depth from the width-walls and one (1) of the length-walls and two and one-quarter inches (2¼″) from the opposite length-wall, at a distance of one inch (1″) from each other.

Each width-wall of the horizontal feeding-bowl-support-plate 12 features a one-hundred and eighty degree (180°) arc with a radius of three inches (3″). The length-wall, two and one-quarter inches (2¼″) from the apertures 13 is reduced to a length of four and one-half inches (4½″). The three inch (3″) radius arc lines feature a tangent line of one-half inch (½″) towards each other leaving a four and one-half inches (4½″) by one and one-half inches (1½″) brace component of the feeding-bowl-support-plate 12.

The horizontal feeding-bowl-support-plate 12 can be made of various materials of applicable weight and durability, such as but not limited to polyvinyl chloride (PVC), fiberglass/resin, high-density polyethylene (HDPE), and polypropylene. Variations that use wood or various metals can also be produced, as well as variations that use a combination of materials. The horizontal feeding-bowl-support-plate 12 can be made in various sizes and shapes, including specific sizes and shapes for its application upon specific models of cat trees. The horizontal feeding-bowl-support-plate 12 can be made in variations to accommodate one (1) or more serving bowls 11. Said feeding bowls 11 shall be supported and attached as close as physically possible to a feeding cat's face/mouth. The horizontal feeding-bowl-support-plate 12 may be made in variations that feature carpeting or other material, and on any portion of its structure.

Said brace component of the horizontal feeding-bowl-support-plate 12 is centered three and one-half inches (½″) inward from each width-wall of the horizontal feeding bowl support plate 12. The inside of the brace component of the horizontal feeding-bowl-support-plate 12 is textured FIG. 6-18 to maintain secure and stable placement.

Attached perpendicularly to the brace component of the horizontal feeding-bowl-support-plate 12 adjacent to the apertures is an “L-shaped” brace component 19. This “L-shaped” brace component 19 measures approximately two (2) inches (2″) in maximum height by two (2) inches (2″) in maximum width by four and one-half inches (4½″) in maximum length by one-half inches (½″) thick.

The vertical distance between the brace component of the horizontal feeding-bowl-support-plate 12 and the four and one-half inch (4½″) horizontal “L-shaped” brace component 19 measures one and one-half inches (1½″). The horizontal “L-shaped” brace 19 features an embedded one-quarter inch (¼″) hex nut 17 that secures the one and one-half inch (1½″) thumb screw 16.

The brace component of the horizontal feeding-bowl-support-plate 12 may be of various sizes and various widths between its two (2) horizontal walls.

The textured surface FIG. 6-18 on the horizontally attachable cat tree feeder 10B, used to secure and stabilize the brace component, can be of various patterns, and such textured surface FIG. 6-18 may be featured on any or both sides of said brace component.

The thumbscrew 16 of the horizontally attachable cat tree feeder 10B can be of various sizes and shapes.

The thumbscrew 16 of the horizontally attachable cat tree feeder 10B may feature, and/or be connected to a plate of various sizes, and for improved dimensions of surface area contact when applied.

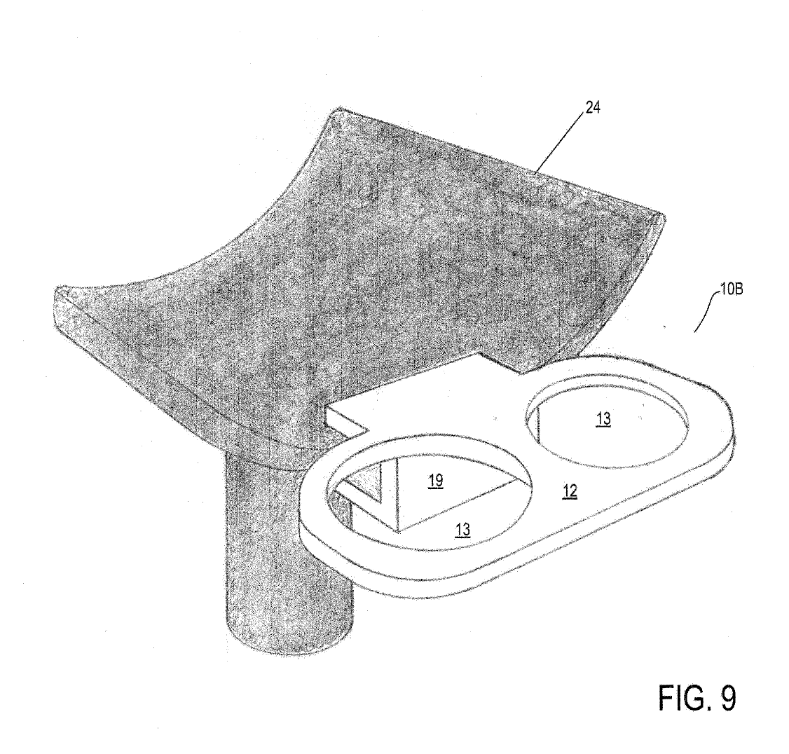

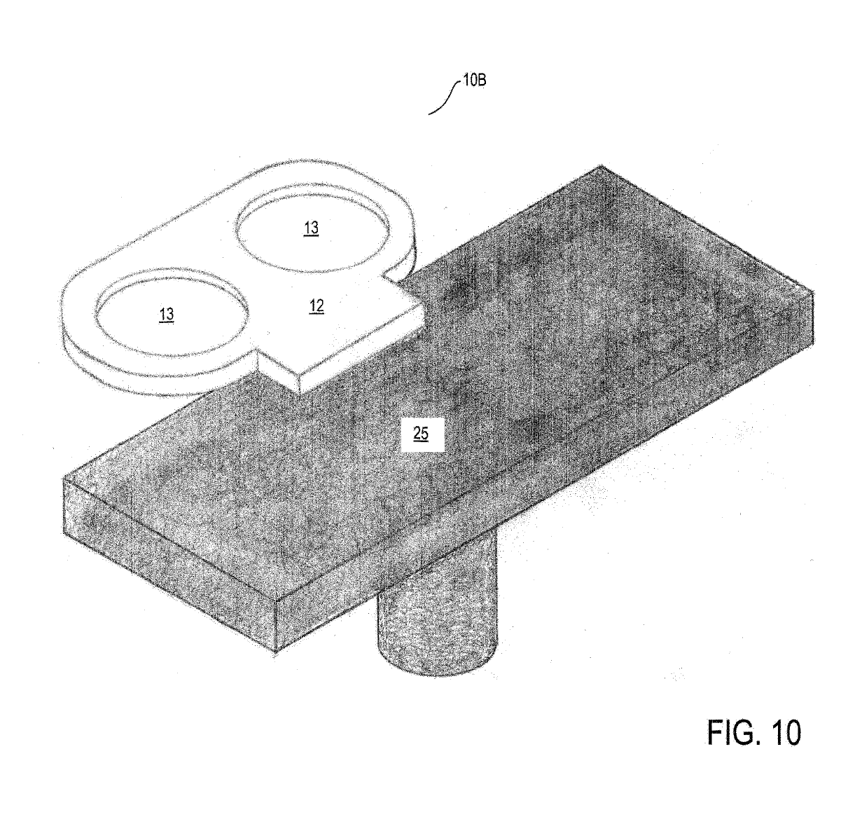

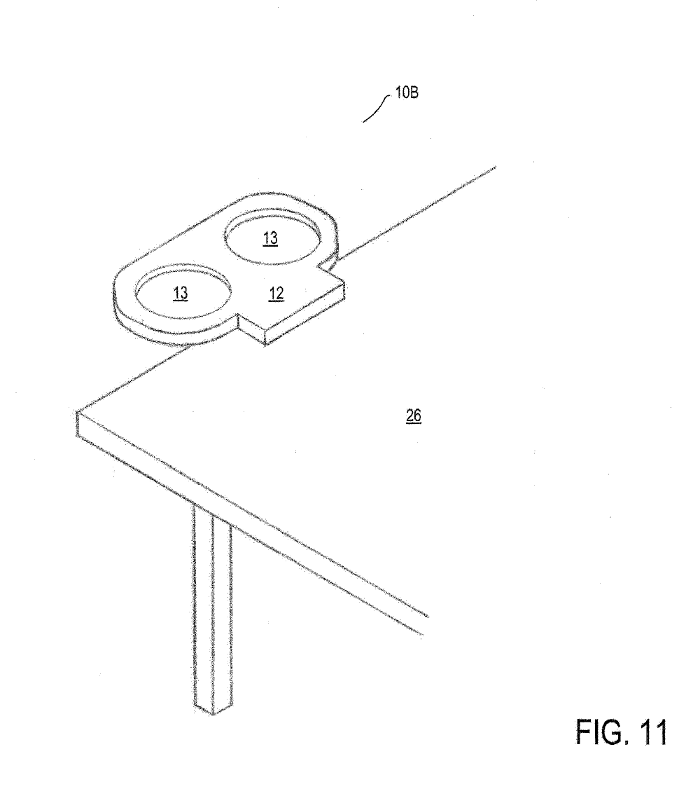

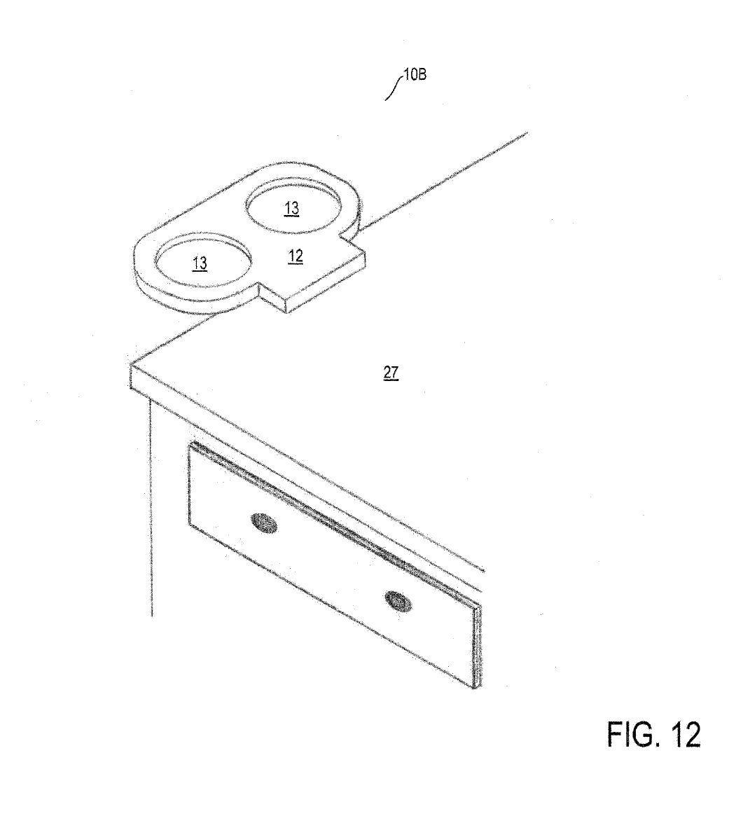

The horizontally attachable cat tree feeder 10B can be attached to a “U” shaped platform FIG. 9-24 of a cat tree, to a flat rectangular platform FIG. 10-25, to a horizontal edge of a table surface FIG. 11-26 to a horizontal edge of a countertop surface FIG. 12-27 by various other methods, such as but not limited to brace, bracket, hook-and-loop material, ratchet clamp, hook and other means.

The horizontally attachable cat tree feeder 10B can be made in variations in which its horizontal feeding-bowl-support-plate 12 features a raised wall about some or all of its perimeter, and for the purpose of preventing spillage of dry cat food. In such variations, the said wall may be of various heights and widths.

The horizontal feeding-bowl-support-plate 12 of the horizontally attachable cat tree feeder 10B can be attached to its brace component by lockable hinge, allowing said top plane to be folded out of the way when not in use.

The brace component of the horizontally attachable cat tree feeder 10B may be made in variations in which the width between its walls is adjustable by the user, and by various means.

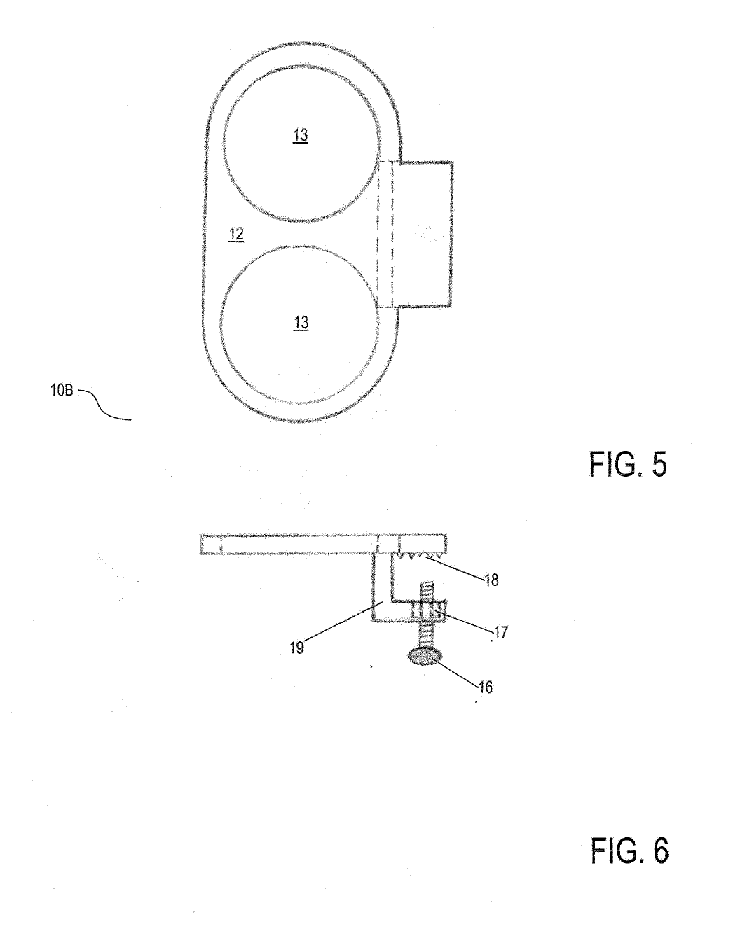

FIG. 5 and FIG. 6 provide a plan and a sectional perspective view of the components of a horizontally attachable cat tree feeder 10B, according to the present invention. Said views detail the horizontal brace component of the horizontally attachable cat tree feeder 10B. The plan view and sectional view illustrate the relation of the said textured 18 brace component of the feeding-bowl-support-plate 12 and the “L-shaped” brace component 19 that features an embedded one-quarter inch (¼″) hex nut 17 that secures the one and one-half inch (1½″) thumb screw 16.

FIG. 7 illustrates the vertically attachable cat tree feeder 10A attached to a vertically straight railing 20 on a rectangular platform 21 of a cat tree.

FIG. 8 illustrates the vertically attachable cat tree feeder 10A attached to a vertically curved railing 22 on a curved platform 23 of a cat tree.

FIG. 9 illustrates the horizontally attachable cat tree feeder 10B attached to the bottom section of a “U” shaped platform 24 of a cat tree.

FIG. 10 illustrates the horizontally attachable cat tree feeder 10B attached to a flat rectangular platform 25 of a cat tree.

FIG. 11 illustrates the horizontally attachable cat tree feeder 10B attached to the horizontal edge of a table surface 26.

FIG. 12 illustrates the horizontally attachable cat tree feeder 10B attached to the horizontal edge of a countertop surface 27.

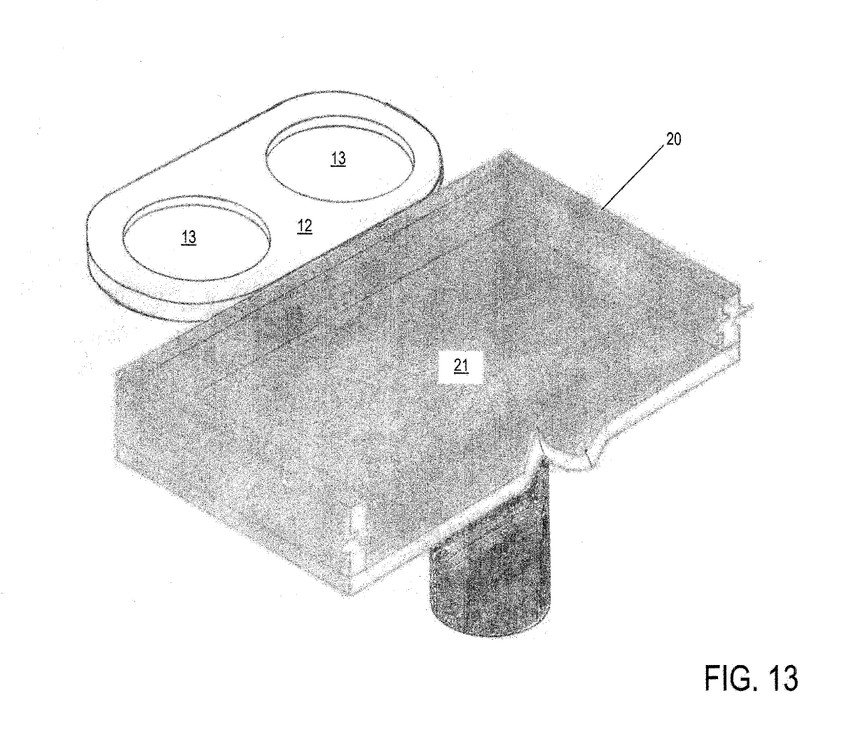

FIG. 13 illustrates a horizontal feeding-bowl-support-plate 12 attached permanently to a vertically straight railing 20 on a rectangular platform 21 of a cat tree.

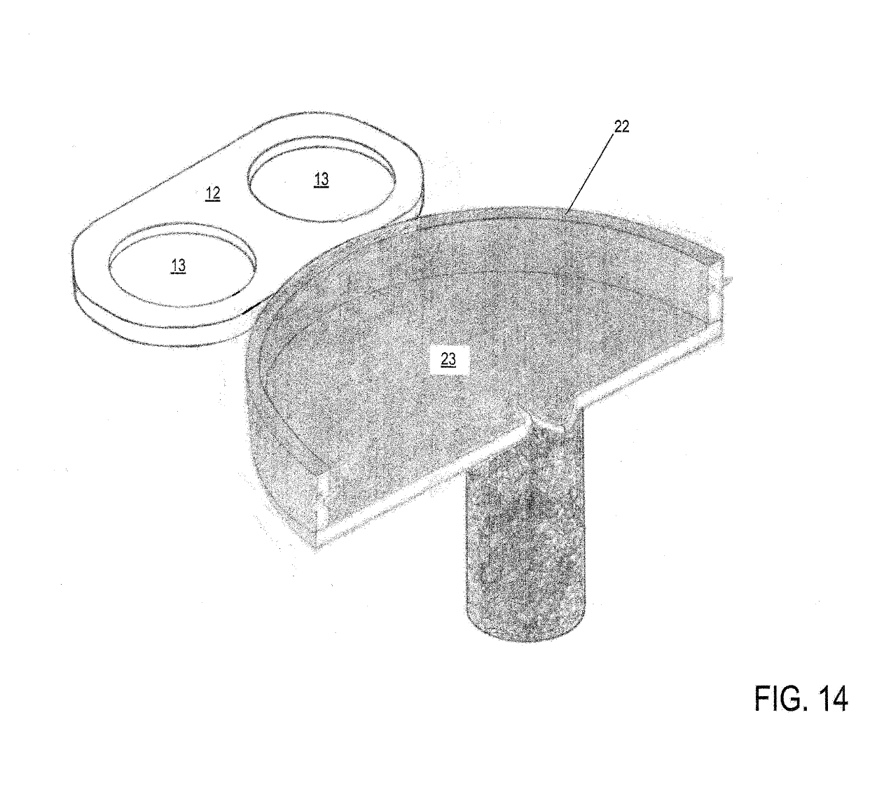

FIG. 14 illustrates a horizontal feeding-bowl-support-plate 12 attached permanently to a vertically curved railing 22 on a curved platform 23 of a cat tree.

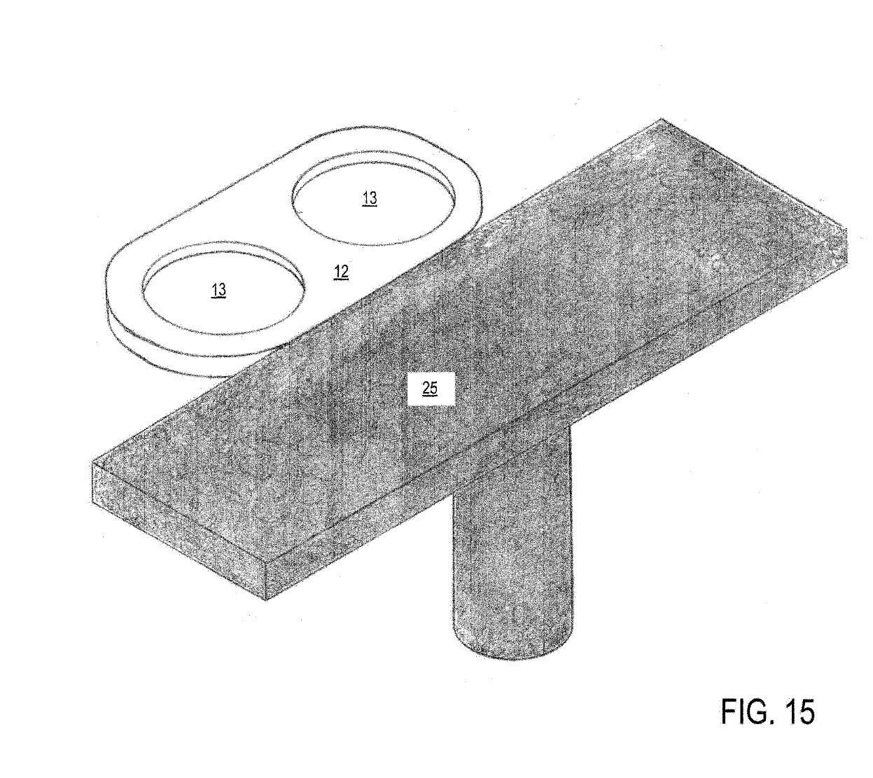

FIG. 15 illustrates a horizontal feeding-bowl-support-plate 12 attached permanently to a flat rectangular platform 25 of a cat tree.

The vertically attachable cat tree feeder 10A and the horizontally attachable cat tree feeder 10B can be made in variations in which it is a pre-attached feature upon a cat tree and in this said attachment may be permanent or removable. The horizontal feeding-bowl-support-plate 12 can be included in the manufacture of a cat tree and therein is a permanent component of a cat tree.

The vertically attachable cat tree feeder 10A and the horizontally attachable cat tree feeder 10B can be made in variations for its attachment upon items other than a cat tree, such as but not limited to a horizontal surface or a railing.

The vertically attachable cat tree feeder 10A and the horizontally attachable cat tree feeder 10B can be combined as a single unit featuring a rotational brace component, a selection or switching brace component or similar brace component that can be interchanged and attachable to the edge of a horizontal surface or the edge of a vertical surface.

The vertically attachable cat tree feeder 10A and the horizontally attachable cat tree feeder 10B can be produced in various colors and may bear various patterns, designs, emblems and/or logos, which may or may not be of registered trademark and/or copyright status.

Thus, the present invention provides for a cat tree feeder that is truly elevated, simple, light-weight, and a convenient cat feeding device.

A number of embodiments of the present invention have been described. Nevertheless, it shall be understood that various modifications may be made without departing from the spirit and scope of the invention. Accordingly, other embodiments are within the scope of the following claims.

What is claimed is:

1. The cat tree feeder; comprising:
a selectively attachable horizontal feeding-bowl-support-plate featuring one or more apertures that support and host feeding bowls;
the horizontal feeding-bowl-support-plate features a vertically attachable brace component;
the horizontal feeding-bowl-support-plate features a horizontally attachable brace component;
the horizontal feeding-bowl-support-plate features a combined vertically attachable and horizontally attachable brace component.

2. The cat tree feeder of claim 1, wherein the horizontal feeding-bowl-support-plate's brace component attaches to the edge of a vertical surface on a cat tree or to the edge of any similar vertical surface.

3. The cat tree feeder of claim 1, wherein the horizontal feeding-bowl-support-plate's brace component attaches to the edge of a horizontal surface on a cat tree or to the edge of any similar horizontal surface.

4. The cat tree feeder of claim 1, wherein the horizontal feeding-bowl-support-plate's brace component attaches to either the edge of a vertical surface on a cat tree or to the edge of any similar vertical surface or attaches to the edge of a horizontal surface on a cat tree or to the edge of any similar horizontal surface.

5. The cat tree feeder; comprising:
a permanently attached horizontal feeding-bowl-support-plate featuring one or more apertures that support and host feeding bowls.

6. The cat tree feeder of claim 5, wherein the horizontal feeding-bowl-support-plate is included in the manufacture of a cat tree and therein is a permanent component of a cat tree.
